(19) United States
(12) Patent Application Publication
(10) Pub. No.: US 2014/0287311 A1
(43) Pub. Date: Sep. 25, 2014

(54) Hetero-nanostructure Materials for Use in Energy-Storage Devices and Methods of Fabricating Same

(71) Applicant: The Trustees of Boston College, Chestnut Hill, MA (US)

(72) Inventors: Dunwei Wang, Newton Highlands, MA (US); Sa Zhou, Fremont, CA (US)

(21) Appl. No.: 14/355,491

(22) PCT Filed: Oct. 31, 2012
(86) PCT No.: PCT/US2012/062723

§ 371 Date: Apr. 30, 2014

Related U.S. Application Data
(60) Provisional application No. 61/553,602, filed on Oct. 31, 2011.

(51) Int. Cl. H01M 4/136; H01M 4/1397

(52) U.S. Cl. CPC H01M 4/136; H01M 4/1397
USPC 429/221; 429/218.1; 429/231.5; 429/223; 429/231.3; 429/224; 429/231.95; 427/58

(57) ABSTRACT

Hetero-nanostructure materials for use in energy-storage devices are disclosed. In some embodiments, a hetero-nanostructure material (100) includes a silicide nanoplatform (110), ionic host nanoparticles (120) disposed on the silicide nanoplatform (110) and in electrical communication with the silicide nanoplatform (110), and a protective coating (130) disposed on the silicide nanoplatform (110) between the ionic host nanoparticles (120). In some embodiments, the silicide nanoplatform (110) includes a plurality of connected and spaced-apart nanobeams comprising a silicide core (110), ionic host nanoparticles (120) formed on the silicide core, and a protective coating (130) formed on the silicide core (110) between the ionic host nanoparticles (120).

### RELATED APPLICATIONS

This application claims the benefit of and priority to U.S. Provisional Application No. 61/553,602, filed on Oct. 31, 2011, which is incorporated herein by reference in its entirety.

### STATEMENT OF GOVERNMENT SUPPORT

This invention was made with Government Support under Contract Number DMR-1055762 awarded by the National Science Foundation. The Government has certain rights in the invention.

### FIELD

The embodiments disclosed herein relate to hetero-nanostructure materials for use in energy-storage devices, and more particularly to hetero-nanostructure materials for use as battery electrodes.

### BACKGROUND

Lithium-ion batteries are a type of rechargeable battery in which lithium ions move from the negative electrode (anode) to the positive electrode (cathode) during discharge, and from the cathode to the anode during charge. Lithium-ion batteries are common in portable consumer electronics because of their high energy-to-weight ratios, lack of memory effect, and slow self-discharge when not in use. In addition to consumer electronics, lithium-ion batteries are increasingly used in defense, automotive, and aerospace applications due to their high energy density. Commercially, the most popular material for the anode for a lithium-ion battery is graphite. The cathode is generally one of three materials: a layered oxide (such as lithium cobalt oxide), one based on a polyanion (such as lithium iron phosphate), or a spinel (such as lithium manganese oxide), although materials such as TiS₂ (titanium disulfide) have been used. Depending on the choice of material for the anode, cathode, and electrolyte, the voltage, capacity, life, and safety of a lithium-ion battery can change dramatically.

Improvements for Li-ion batteries focus on several areas, and often involve advances in nanotechnology and microstructures. Technology improvements include, but are not limited to, increasing cycle life and performance (decreases internal resistance and increases output power) by changing the composition of the material used in the anode and cathode, along with increasing the effective surface area of the electrodes and changing materials used in the electrolyte and/or combinations thereof; improving capacity by improving the structure to incorporate more active materials; and improving the safety of lithium-ion batteries.

### SUMMARY

Hetero-nanostructure materials for use as battery electrodes and methods of fabricating same are disclosed herein.

According to some aspects disclosed herein, there is provided a hetero-nanostructure material that includes a silicide nanoplatform, ionic host nanoparticles disposed on the silicide nanoplatform and in electrical communication with the silicide nanoplatform, and a protective coating disposed on the silicide nanoplatform between the ionic host nanoparticles.

According to some aspects disclosed herein, there is provided a hetero-nanostructure material that includes a plurality of connected and spaced-apart nanobeams comprising a silicide core, ionic host nanoparticles formed on the silicide core, and a protective coating formed on the silicide core between the ionic host nanoparticles.

According to some aspects disclosed herein, there is provided an electrode for a lithium battery that includes a silicide nanoplatform formed on a substrate, ionic host nanoparticles disposed on the silicide nanoplatform and in electrical communication with the silicide nanoplatform, and a protective coating disposed on the silicide nanoplatform between the ionic host nanoparticles. In some embodiments, the nanoplatform includes a plurality of connected and spaced-apart nanobeams linked together at an about 90-degree angle. In some embodiments, the electrode of the present disclosure includes a titanium silicide nanoplatform which functions to facilitate charge transport, titanium doped vanadium pentoxide nanoparticles which function as an active component to store and release lithium-ion (Li⁺), and silicon oxide protective coating which functions to prevent Li⁺ from reacting with the silicide nanoplatform.

In some aspects of the present disclosure, there is provided a method of fabricating a hetero-nanostructure material that includes forming a two-dimensional silicide nanonet including a plurality of connected and spaced-apart nanobeams; depositing precursor for an ionic host material on a surface of the silicide nanonet; and forming ionic host material nanoparticles on the surface of the silicide nanonet and a protective coating between the nanoparticles.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIGS. 1A-1D is a schematic diagram of hetero-nanostructures of the present disclosure.

FIG. 2 shows a CVD system that can be used in some embodiments of a method of fabricating hetero-nanostructures of the present disclosure.

FIG. 3A and FIG. 3B present schematic illustrations of an embodiment of an electrode 300 utilizing hetero-nanostructures of the present disclosure.

FIG. 3C provides a schematic diagram of an embodiment storage device of the present disclosure.

FIG. 4A, FIG. 4B, and FIG. 4C present electron micrographs of embodiment TiSi₂/V₂O₅ hetero-nanostructures of the present disclosure.

FIGS. 5A-5E summarize charge and discharge behaviors of embodiment TiSi₂/V₂O₅ hetero-nanostructures of the present disclosure.

FIG. 6A, FIG. 6B, and FIG. 6C present images of embodiment TiSi₂/V₂O₅ hetero-nanostructures of the present disclosure after 1,500 cycles of repeated charge/discharge.

FIG. 7A, FIG. 7B, and FIG. 7C present results of Energy Dispersive Spectroscopy (EDS) analysis of embodiment TiSi₂/V₂O₅ particles of the present disclosure.

FIG. 8 presents a graph showing charge characteristic of the first cycle at a rate of 540 mA/g.

FIG. 9A presents the Nyquist plot of TiSi₂/V₂O₅ heterostructures electrode at 1.9 V.

FIG. 9B presents linear fitting of the imaginary resistance Z″ against (2πf)^{-1/2}.

FIG. 10 shows the dependence between temperature and capacity of a cathode of the present disclosure.

FIG. 11A, FIG. 11B, and FIG. 11C present TEM images of TiSi₂ nanonets of the present disclosure.

FIG. 12A and FIG. 12B present current-voltage characteristics of TiSi₂N₂O₅ hetero-nanostructures of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

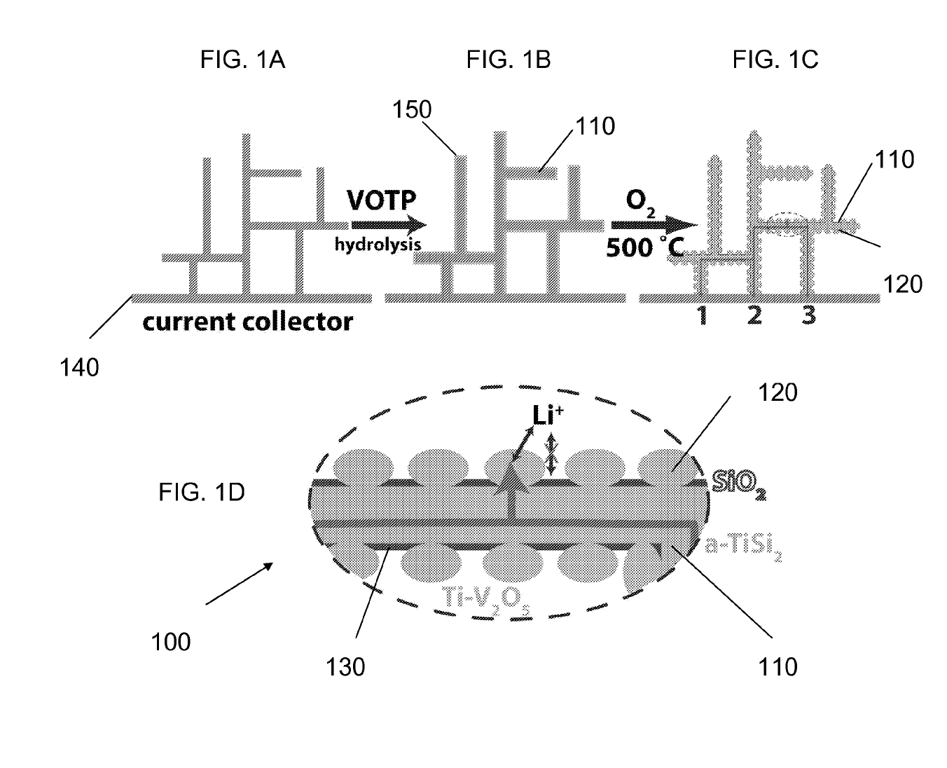

Hetero-nanostructure materials for use in an electrode for an energy-storage device are disclosed and are illustrated in FIGS. 1A-1D. In particular, FIG. 1D illustrates an embodiment hetero-nanostructure 100 of the present disclosure that includes a two-dimensional (2D) conductive nanoplatform 110 for charge transport combined with an active material nanoparticles 120 that serve as the ionic host formed on a substrate. In some embodiments, the hetero-structures 100 of the present disclosure also include a protective coating 130, such as a protective oxide film, on the surface of the nanoplatforms 110. In some embodiments, the nanoplatforms 110 are formed on a conductive substrate 140.

Nanoplatforms

The nanoplatform may be in the form of a nanonet, nanowire, nanorod, nanotube, nanoparticles or similar structure. In some embodiments, the nanoplatform is a nanonet or has a mesh like structure, as shown in FIG. 1A. In some embodiments, the 2D conductive nanoplatform is a free-standing nanostructure. In some embodiments, the nanoplatform is single crystalline complex 2D network composed of a plurality of nanonet (NN) sheets, formed by optimizing various processing parameters during fabrication. In some embodiments, the nanoplatform includes a plurality of nanonet sheets that are stacked on top of one another. In some embodiments, the nanoplatform includes a plurality of nanonet sheets that are parallel to one another. In some embodiments, the nanonet sheets are stacked in an approximately horizontal direction. In some embodiments, each nanonet sheet is a complex structure made up of nanobeams that are linked together by single crystalline junctions with 90-degree angles. In some embodiments, each nanobeam is approximately 15 nm thick, 20-30 nm wide, and at least about 1 μm long. Crystals with hexagonal, tetragonal, and orthorhombic lattices are good choices for 2D complex nanostructures of the present disclosure. The nanoplatform can be formed from a any materials with high surface area and high conductivity. Suitable examples include, but are not limited to, silicides, metal nanowires (such as Ni nanowires), carbon nanotubes, carbon nanofibers, graphene and combinations thereof. Non-limiting examples of suitable nanoplatforms and methods of synthesis thereof are disclosed, for example, in U.S. Pat. No. 8,158,254 and in Sa Zhou, Xiaohua Liu, Yongjing Lin, Dunwei Wang, “Spontaneous Growth of Highly Conductive Two-dimensional Single Crystalline TiSi₂ Nanonets,” Angew. Chem. Int. Ed., 2008, 47, 7681-7684, which are incorporated herein by reference in their entireties.

In some embodiments, the nanoplatform can be formed from a silicide. Silicides are highly conductive materials formed by alloying silicon with selected metals. Silicides are commonly used in Si integrated circuits to form ohmic contacts. Suitable silicides for forming hetero-nanostructures of the present disclosure include, but are not limited to, titanium silicide, nickel silicide, iron silicide, platinum silicide, chromium silicide, cobalt silicide, molybdenum silicide and tantalum silicide.

In some embodiments, the nanoplatform is a titanium silicide (TiSi₂) nanonet. Titanium silicide (TiSi₂) is an excellent electronic material and is one of the most conductive silicides (resistivity of about 10 micro-ohm-centimeters (μΩ·cm)). TiSi₂ has recently been demonstrated to behave as a good photocatalyst to split water by absorbing visible light, a promising approach toward solar H₂ as clean energy carriers. Better charge transport offered by complex structures of nanometer-scaled TiSi₂ is desirable for nanoelectronics and solar energy harvesting. Capabilities to chemically synthesize TiSi₂ are therefore appealing because they will enable these important applications. Synthetic conditions required by the two key features of complex nanostructures, low dimensionality and complexity, however, seem to contradict each other. Growth of one-dimensional (1D) features involves promoting additions of atoms or molecules in one direction while constraining those in all other directions, which is often achieved either by surface passivation to increase energies of sidewall deposition (such as solution phase synthesis) or introduction of impurity to lower energies of deposition for the selected directions (most notably the vapor-liquid-solid mechanism). Complex crystal structures, on the other hand, require controlled growth in more than one direction. The challenge in making two-dimensional (2D) complex nanostructures is even greater as it demands more stringent controls over the complexity to limit the overall structure within two dimensions. The successful chemical syntheses of complex nanostructures have been mainly limited to three-dimensional (3D) ones. In principle, 2D complex nanostructures are less likely to grow for crystals with high symmetries, e.g. cubic, since various equivalent directions tend to yield a 3D complex structure; or that with low symmetries, e.g. triclinic, monoclinic or trigonal, each crystal plane of which is so different that simultaneous growths for complexity are prohibitively difficult.

### Synthesis of Nanoplatforms

The nanoplatforms of the present disclosure may be synthesized by a variety of methods. In some embodiments, the nanoplatform may be synthesized using chemical vapor deposition (CVD). Examples of CVD methods include but are not limited to, plasma enhanced chemical vapor deposition (PECVD), hot filament chemical vapor deposition (HFCVD), and synchrotron radiation chemical vapor deposition (SRCVD). In some embodiments, the nanoplatform may be synthesized using various gas phase deposition methods, including, but not limited to, atomic layer deposition, chemical vapor deposition, pulse laser deposition, evaporation and solution synthesis approach and similar methods.

In some embodiments, methods for synthesizing 2D conductive silicide nanonets are provided. In some embodiments, careful control of the feeding of the synthesis precursors is necessary for obtaining the nanonets disclosed herein. Unbalanced feeding of either the precursors or the overall concentration in the reaction chamber, can lead to failed growth of the nanonets. In some embodiments, careful control of the carrier gas is necessary for obtaining the nanonets disclosed herein, as the carrier gas reacts with both precursors, as well as acts as a protecting gas by providing a reductive environment.

In some embodiments, the nanonet may be synthesized without the involvement of catalysts. An important distinguishing characteristic of the methods disclosed herein is that the nanonets are spontaneously formed, without the need for supplying growth seeds. This eliminates the limitations that many other nanostructure synthesis methods require, and thus extend the nanostructures applications in fields where impurities (from hetergeneous growth seeds) are detrimental. The substrates that the disclosed nanostructures can be grown on are versatile, so long as the substrate sustains the temperatures required for the synthesis. In some embodiments, the nanostructures are grown on a transparent substrate. The nanostructures fabricated according to the methods of the presently disclosed embodiments can provide superior conductivity, excellent thermal and mechanical stability, and high surface area.

In some embodiments, the synthesis of nanonets is carried out on a conductive substrate that can be part of the cathode of the present disclosure. In this manner, the resulting materials can be directly assembled into coin cells for battery characterizations without the need for binders or other additives. In some embodiments, the nanonet is synthesized on a titanium coil. In some embodiments, the titanium coil can be platinum coated. Other suitable conductive substrates include, but are not limited to, platinum coated or uncoated stainless steel or tungsten coil.

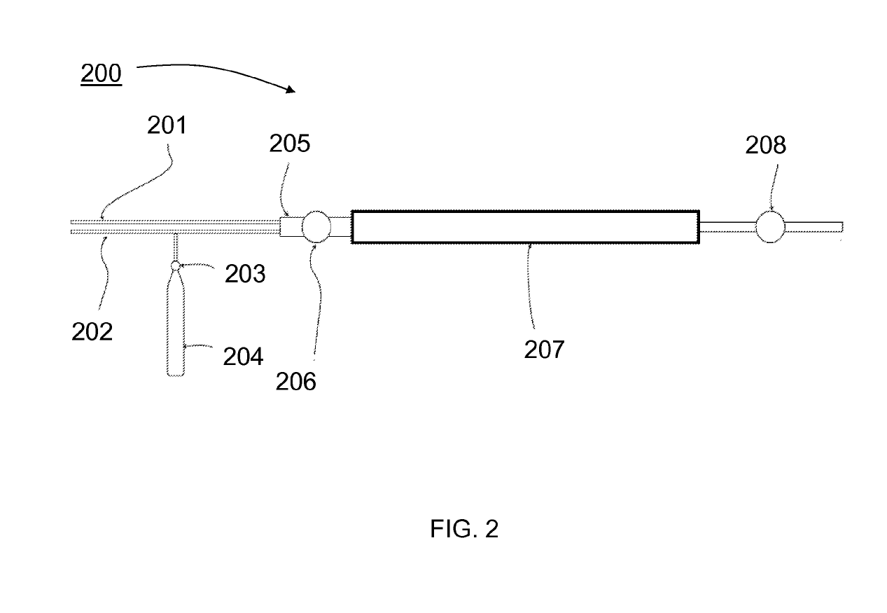

FIG. 2 shows a CVD system 200 used for an embodiment of a method of fabricating 2D conductive nanonets of the present disclosure. The CVD system 200 has automatic flow and pressure controls. Flow of a precursor fluid and a carrier fluid are controlled by mass flow controllers 201 and 202 respectively, and fed to a growth (reaction) chamber 207 at precise flow rates. A precursor fluid is stored in a cylinder 204 and released to the carrier fluid mass flow controller 202 through a metered needle control valve 203. All precursors are mixed in a pre-mixing chamber 205 prior to entering the reaction chamber 207. The pressure in the reaction chamber 207 is automatically controlled and maintained approximately constant by the combination of a pressure transducer 206 and a throttle valve 208.

The 2D conductive nanonets disclosed herein may be spontaneously fabricated in the chemical vapor deposition system 200 when the precursors react and/or decompose on a substrate in the growth chamber 207. This spontaneous fabrication occurs via a seedless growth, i.e., no growth seeds are necessary for the growth of the 2D conductive nanonets. Therefore, impurities are not introduced into the resulting conductive nanonets. The fabrication method is simple, no complicated pre-treatments are necessary for the receiving substrates. The growth is not sensitive to surfaces (i.e., not substrate dependent). The substrates that the disclosed conductive nanonets can be grown on are versatile, so long as the substrate sustains the temperatures required for the synthesis. In some embodiments, the 2D conductive nanonets are grown on a transparent substrate. No inert chemical carriers are involved (the carrier fluid also participates the reactions). It is believed that due to the nature of the synthesis of the 2D conductive nanonets disclosed herein, a continuous synthesis process may be developed to allow for roll-to-roll production.

In some embodiments, the 2D conductive nanonets are titanium silicide nanonets, such as titanium silicide (TiSi₂) nanonets. The following detailed description will focus on the fabrication of 2D titanium silicide nanonets, however, it should be noted that other 2D conductive silicide nanonets, as well as conductive nanonets of materials other than silicide, can be fabricated using the methods of the presently disclosed embodiments, including, but not limited to, nickel silicide, iron silicide, platinum silicide, chromium silicide, cobalt silicide, molybdenum silicide and tantalum silicide.

By way of a non-limiting example, to prepare 2D conductive silicide nanonets, the flow rate for the precursor fluid is between about 20 standard cubic centimeters per minute (sccm) and about 100 sccm. In some embodiments, the flow rate for the precursor fluid is about 50 sccm. In some embodiments, the precursor fluid is present at a concentration ranging between about 1.3×10⁻⁶ mole/L to about 4.2×10⁻⁶ mole/L. In some embodiments, the precursor fluid is present at a concentration of about 2.8±1×10⁻⁶ mole/L. The flow rate for the carrier fluid is between about 80 standard cubic centimeters per minute (sccm) and about 130 sccm. In some embodiments, the flow rate for the carrier fluid is about 100 sccm. The flow rate for the precursor fluid is between about 1.2 sccm and 5 sccm. In some embodiments, the flow rate for the precursor fluid is about 2.5 sccm. In some embodiments, the precursor fluid is present at a concentration ranging from about 6.8×10⁻⁷ mole/L to about 3.2×10⁻⁶ mole/L. In some embodiments, the flow rate for the precursor fluid is present at a concentration of about 1.1±0.2×10⁻⁶ mole/L.

In some embodiments, the system 200 is kept at a constant pressure of about 5 Torr during growth. The variation of the pressure during a typical growth is within 1% of a set point. All precursors are kept at room temperature before being introduced into the reaction chamber 207. A typical reaction lasts from about five minutes up to about twenty minutes. The reaction chamber 207 is heated by a horizontal tubular furnace to temperature ranging from about 650° C. to about 685° C. In some embodiments, the reaction chamber 207 is heated to a temperature of about 675° C.

In some embodiments, the precursor fluid is a titanium containing chemical. Examples of titanium containing chemicals include, but are not limited to, titanium beams from high temperature (or electromagnetically excited) metal targets, titanium tetrachloride (TiCl₄), and titanium-containing organomettalic compounds. In some embodiment, the precursor fluid is a liquid. In some embodiments, the precursor fluid is a silicon containing chemical. Examples of silicon containing chemicals include, but are not limited to, silane (SiH₄), silicon tetrachloride (SiCl₄), disilane (Si₂H₆), other silanes, and silicon beams by evaporation. In some embodiments, the carrier fluid is selected from the group consisting of hydrogen (H), hydrochloric acid (HCl), hydrogen fluoride (HF), chlorine (Cl₂), fluorine (F₂), and an inert fluid.

It should be noted that although the foregoing detailed description of an embodiment method for fabricating nanoplatforms of the present disclosure focused on the fabrication of 2D titanium silicide (TiSi₂) nanonets, other 2D conductive nanostructures, such as those made of other materials and/or having a different configuration, can be fabricated using the methods of the presently disclosed embodiments.

### Active Material

As shown in FIG. 1C, active material nanoparticles 120 are formed on the surfaces of the conductive silicide nanoplatform 110 to act as the ionic host. In some embodiments, active material has, without limitation, the following properties: 1) no reactivity with the electrolyte at high potentials; 2) reactivity with Li⁺; 3) ability to store and release Li⁺; and 4) have well-defined electrochemical potentials when reacting with Li+. Suitable active materials include, but are not limited to, vanadium pentoxide, lithium cobalt oxide, lithium iron phosphate, lithium manganese oxide, lithium nickel oxide, and compositions thereof.

In some embodiments, the active material nanoparticles may be doped to provide stabilization of the crystal structure of the active material, such as upon lithiation and delithiathion. Suitable dopants include, but are not limited to, titanium, nickel, cobalt, iron and tin. In some embodiments, the dopant is titanium.

### Protective Coating:

In some embodiments, a protective coating is deposited over a nanoplatform to protect the nanoplatform by passivating the surface of the nanoplatform. In some embodiments, the protective surface prevent Li⁺ from reacting with TiSi₂, which otherwise would lead to the destruction of the nanostructures. In some embodiments, the protective coating is a silicon oxide.

### Synthesis of Active Material Nanoparticles and Protective Coating

Nanoparticles of the active material are synthesized on the surface of the conductive nanoplatform. In some embodiments, a precursor for the active material may be deposited onto the nanoplatform to form a coating on the surface of the nanoplatform, and the nanoplatform with the active material precursor is calcined at a predetermined temperature to form active material nanoparticles on the surfaces of the nanoplatform.

In some embodiments, conductive silicide nanoplatform with vanadium pentaxide may be prepared according to methods disclosed herein. Suitable precursors for vanadium pentoxide, include without limitation, triisopropoxyvandium (V) oxide (VOTP), vanadium triisobutoxide, vanadium oxide tris(methoxyethoxide), vanadium tri-n-propoxide oxide or combinations thereof.

As shown in FIG. 1B, vanadium pentoxide precursor may be deposited on the surface of the nanoplatform by a variety of methods, including, but not limited to, sol-gel, chemical vapor deposition, atomic layer deposition, sputtering or other methods known in the art. In some embodiments, a modified sol-gel method is used to form active material nanoparticles. (See e.g. Patrissi et al. (1999) “Sol-Gel-Based Template Synthesis and Li-Insertion Rate Performance of Nanostructured Vanadium Pentoxide,” J. Electrochem. Soc. 146:3176-3180).

In some embodiments, the deposition of the vanadium pentoxide precursor on the nanoplatform is carried out in a glovebox. In some embodiments, an Ar-filled glove box can be utilized. Alternatively, other inert fluids, such as for example, helium or nitrogen, can be used to fill the glove box. The nanoplatform is placed in the glove box, and the active material precursor is applied on the surface of the nanoplatform. In some embodiments, the complex of the nanoplatform and vanadium pentoxide precursor is allowed to age within the glovebox for between about 2 to about 24 hours. In some embodiments, the aging step is allowed to proceed for about 13 hours. The aging step enables the vanadium pentoxide precursor to react with the trace amount of moisture within a glove box to undergo hydrolysis. Allowing the hydrolysis step to take place in the glove box and over a sufficient amount of time ensures that the vanadium pentoxide precursor forms a uniform coating on the nanoplatform. In contrast, it has been shown that fast hydrolysis in ambient air produces inferior coating that, among other things, can easily crack with high temperature annealing.

In some embodiment, once the vanadium pentoxide precursor coating is sufficiently formed over the nanoplatform, the sample may be brought into ambient air and may be heated for more complete hydrolysis of vanadium pentoxide precursor. The heating step may occur at between about 60 and about 120° C. for about 1 to about 5 hours. In some embodiments, the heating cycle can be carried out at 80° C. for 2 hours. In some embodiments, the heating cycle can be repeated for additional loading of the active material. In some embodiments, the heating cycle is repeated twice.

In some embodiments, conductive silicide nanoplatform with lithium cobalt oxide may be prepared according to methods disclosed herein. Suitable precursors for lithium cobalt oxide include, without limitations, Co(OH)₂, LiOH and O₂, deposited by, for example, a precipitation method, LiCoO₂ deposited by, for example, a sputtering method, Li₂CO₃ and CoCO₃ deposited by, for example, a solid state reaction method, LiNO₃, Co(CH₃COO)₂ and Polyethylene glycol deposited by, for example, a sol-gel method, or Co(NO₃)₂, NaOH and LiOH deposited by, for example, a hydrothermal reaction method.

In some embodiments, conductive silicide nanoplatform with lithium iron phosphate may be prepared according to methods disclosed herein. Suitable precursors for lithium iron phosphate include, but not limited to, FeSO₄, H₃PO₄ and LiOH deposited by, for example, a hydrothermal reaction method, or Li₃PO₄, H₃PO₄ and FeC₆H₈O₇ (ferric citrate) deposited by, for example, a sol-gel method.

In some embodiments, conductive silicide nanoplatform with lithium manganese oxide may be prepared according to methods disclosed herein. Suitable precursors for lithium manganese oxide include, but not limited to, lithium acetate dehydrate and manganese acetate tetrahydrate dissolved in alcoholic solvent deposited by, for example, electrostatic spray deposition method; or manganese acetate and lithium carbonate deposited by a precipitation method.

In some embodiments, conductive silicide nanoplatform with lithium nickel oxide may be prepared according to methods disclosed herein. Suitable precursors for lithium nickel oxide include, but not limited to, Ni(NO₃)₂, LiOH and NH₄OH deposited by, for example, a precipitation method, LiNiO₂ as the target deposited by, for example, a sputtering method, or NiO, Li₂O, LiO₂ and Li₂CO₃ deposited by, for example, a solid state reaction method.

In reference to FIG. 1C and FIG. 1D, when a desired deposition of the active material on the nanoplatform is achieved, the next step is calcining of the nanoplatform and active material. This step can be carried out in dry O₂ or another oxygen-containing oxidants such as NO₂ or H₂O. The calcining step can be carried out at between about 350 and about 550° C. for about 1 hour to about 5 hours.

It was unexpectedly found that the step of calcining serves two independent purposes: formation of a protective film on the surface of the nanoplatform and formation of doped active material nanoparticles. By way of non-limiting example, calcination of a nanoplatform made of titanium silicide results in the formation of a SiO₂ passivation film on the surface of the nanoplatform that protects the TiSiₛ nanoplatform from reacting with other elements, such as Li⁺, which can lead to the premature failure of hetero-nanostructures of the present disclosure. Moreover, the calcination step results in the formation of discrete active material nanoparticles doped with Ti, which comes from the TiSi₂ nanoplatform as the top layer of the nanoplatform is converted to SiO₂ passivation film. As note above, doping of active material nanoparticles was found to stabilize the crystal structure of the nanoparticles.

### Applications

The hetero-nanostructure of the present disclosure can be used in a variety of applications, including, but not limited to, for manufacturing electrodes for energy storage devices, as sensors, interconnectors in electronic devices, and catalysts.

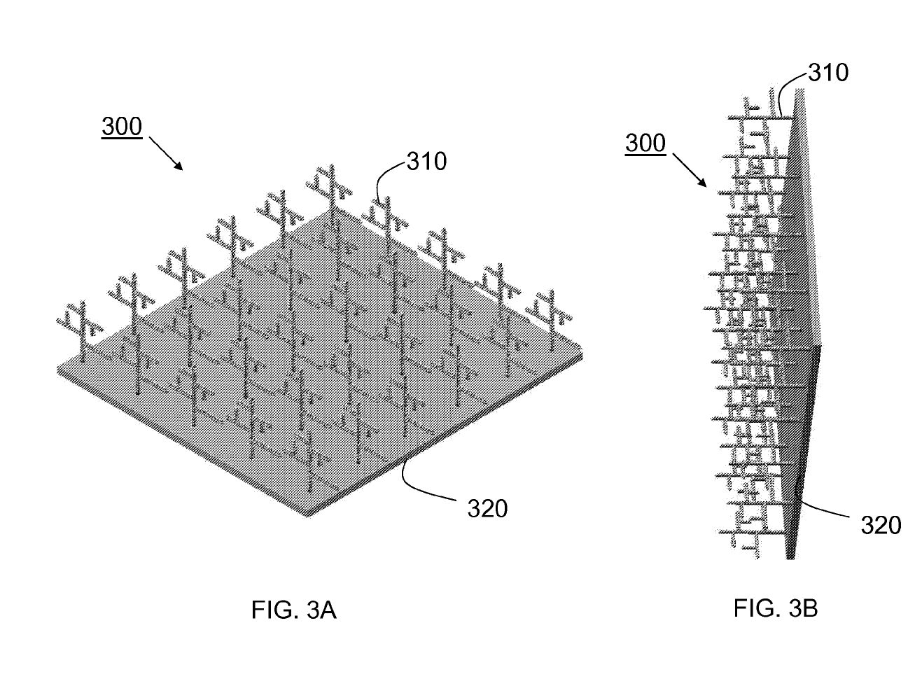

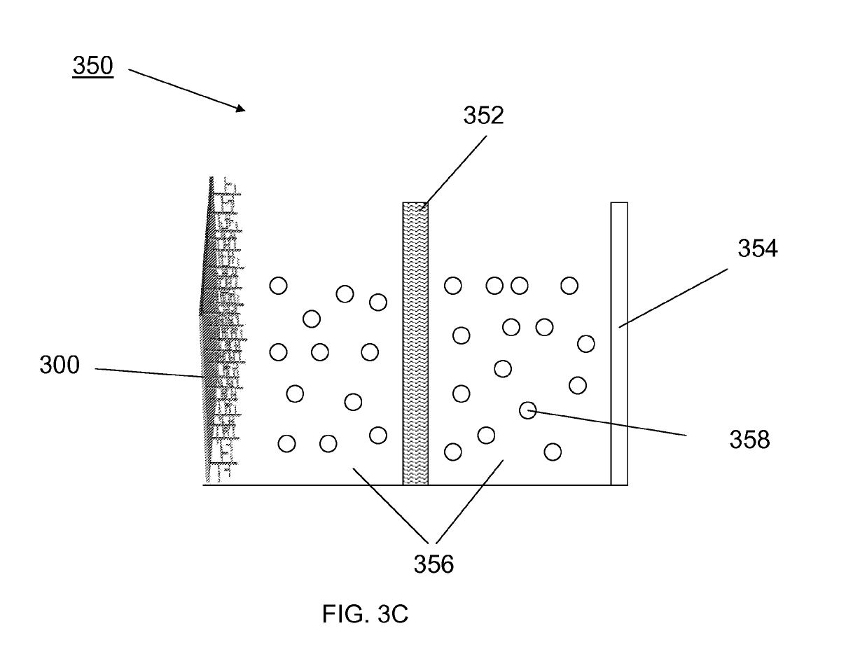

FIG. 3A and FIG. 3B show schematic illustrations of an embodiment of an electrode 300 utilizing hetero-nanostructures of the present disclosure. FIG. 3A is a perspective view of the electrode 300 and FIG. 3B is a side view of the electrode 300. The electrode 300 includes a plurality of hetero-nanostructures of the present disclosure 310 formed on a surface of a substrate 320, which acts as current collector. In some embodiments, the substrates 320 on which the foregoing hetero-nanostructures 310 can be formed are those that can survive from the growth temperature, including, but not limited to, platinum coated or uncoated tungsten foil, stainless steel coil, or titanium foil.

In reference to FIG. 3C, In some embodiments, the electrode 300 is used as the cathode material for a Li-ion battery cell 350. The battery cell 350 can be used in film, coin cells, or cylinder batteries. The battery cell 350 includes a cathode 300 formed using hetero-nanostructures of the present disclosure, anode 354, a separator 352 and electrolyte 356 containing Li-ions. Using cathodes 300 of the present disclosure in the battery cell 350 can result in faster charge time (less than 2 minutes), high power (up to 16 kW/kg), and longer lifetime. In some embodiments, the anode 354 may also be formed using a hetero-nanostructure assembly. In some embodiments, the anode 354 may be formed using the same nanoplatform as the cathode 300, but combined with a different active material which maybe suitable for an anode. In some embodiments, a suitable hetero-nanostructure combines TiSi₂ two-dimensional (2D) conductive nanonets with Si coating, such as disclosed in a co-owned PCT Application No. PCT/US2010/053951, the entirety of which is hereby incorporated herein by reference for the teachings therein. It should be noted that although electrode 300 is described in relation to Li-ion battery, the electrode 300 may also be utilized in connection with other types of batteries and energy-storage devices.

In some embodiments, the cathode 300 includes a plurality TiSi₂ two-dimensional (2D) conductive nanonets formed on a platinum coated titanium substrate and having titanium-doped V₂O₅ active material nanoparticles deposited on the surface of the TiSi₂ nanonets, and further including a SiO₂ coating as a protection on the surface of the TiSi₂ nanonets. This design allows control of materials' features on multiple levels concurrently. At the atomic scale, Ti-doping is used to stabilize the crystal structure of V₂O₅ upon lithiation and delithiation, which dramatically improves the cycle lifetime. At the nanoscale, the material is comprised of more than one component, each designed for a specific function, the TiSi₂ nanonet for charge transport, the Ti-doped V₂O₅ nanoparticle as the ionic host, and the SiO₂ coating as a protection to prevent Li⁺from reacting with TiSi₂, which otherwise would lead to the destruction of the nanostructures. The strategy of having multiple components at the nanoscale may offer an advantage of achieving desired electronic and ionic properties on the same material by tailoring the constituent components. In some embodiments, electrodes of the present disclosure have a specific capacity of 350 mAh/g, a power rate of 14.5 kW/kg, and a capacity retention of 78% after 9,800 cycles of repeated charge/discharge.

In some embodiments, the addition of a conductive framework is particularly useful to solve the key issues of poor conductivity and slow Li⁺ diffusion that limits the performance of V₂O₅. In some embodiments, the cathodes of the present disclosure have both high capacity (at 441 mAh/g, V₂O₅ exhibits one of the highest specific capacities as a stable cathode compound) and high power. In a typical TiSi₂/V₂O₅ nanostructure, the mass of V₂O₅ accounts for ca. 80% of the total mass as measured by elemental analysis, resulting in a capacity of about 350 mAh/g for the overall nanostructure.

In some embodiments, the novel hetero-nanostructures based on the unique nanonet platform, where the active material was Ti-doped V₂O₅ and the structural support and charge transporter was TiSi2 nanonets was achieved. The unique two-dimensional nanonet platform allows one to bridge different length scales from the nanoscale to the micro/macro scale. By introducing active material as a dedicated charge transporter, charge and ionic behaviors can be separated to obtain unprecedented high power and high capacity on a cathode material that can be cycled extensively. Moreover, the hetero-nanostructures of the present disclosure and electrodes made from the hetero-nanostructures of the present disclosure are highly modular, and other high performance cathode compounds (such as LiFePO4) can be readily integrated into the nanonet-based design.

Examples of synthesizing and using the hetero-nanostructures of the present disclosure are provided below. These examples are merely representative and should not be used to limit the scope of the present disclosure. A large variety of alternative designs exist for the materials, methods and devices disclosed herein. The selected examples are therefore used mostly to demonstrate the principles of the devices and methods disclosed herein.

### EXAMPLES

### Example 1

### Methods and Materials

### TiSi₂ Synthesis

TiSi₂ nanonets were synthesized by chemical vapor deposition (CVD) following previously published procedures (See e.g., Sa Zhou, Xiaohua Liu, Yongjing Lin, Dunwei Wang, “Spontaneous Growth of Highly Conductive Two-dimensional Single Crystalline TiSi₂ Nanonets,” Angew. Chem. Int. Ed., 2008, 47, 7681-7684, which are incorporated herein by reference in their entireties). Briefly, 50 seem (standard cubic centimeter per minute) SiH₄ (10% in He; Airgas), and 2 sccm TiCl₄ (Sigma-Aldrich, 98%) carried by 100 sccm H₂ (Airgas) were delivered into the growth chamber, which was heated to 675° C. and kept at 5 Torr during the growth. A Ti foil (Sigma-Aldrich; 0.127 mm) was used as the receiving substrate and subsequently as the current collector for coin cell fabrications. After 12 min of reactions, the supply of SiH₄ was cut off while TiCl₄ and H₂ flow was maintained for 3 min. The sample was then transferred into an Ar-filled glove box (Vacuum Atmosphere Co.) for V₂O₅ deposition.

### V₂O₅ Deposition

V₂O₅ deposition was carried out in the glovebox, where a drop (3 μL) of isopropoxyvanadium (V) oxide (VOTP; Strem Chemical, >98%) was applied on the surface of TiSi₂ nanonets (1×1 cm²) by a syringe. Afterward, the sample was allowed to age within the glovebox for 12 hr, during which time VOTP reacted with the trace amount of moisture (<5 ppm) within the glovebox to undergo hydrolysis. This slow reaction step was found critical because it led to the formation of a uniform coating of V₂O₅ on TiSi₂. Hydrolysis in ambient air produced porous V₂O₅ that behaved poorly in battery characterizations. Once the coating was formed, the sample was brought into ambient air and was heated at 80° C. for 2 hr to allow for more complete hydrolysis. This process was repeated for more loading of V₂O₅. It was discovered that two such cycles produced TiSi₂ nanostructures with ca. 80% (wt %) of V₂O₅. When desired V₂O₅ deposition was achieved, the sample was calcined in dry O₂ at 500° C. for 2 hr to conclude the preparation procedure.

### Coin Cell Fabrication

CR2032-type coin cells were assembled in the glove box (O₂<2 ppm) using an MTI hydraulic crimping machine (model number EQ-MSK-110) with a lithium foil as the anode (Sigma; 0.38 mm thick). The electrolyte was LiPF6 (1.0 M) dissolved in ethylene carbonate and diethyl carbonate (1:1 wt/wt; Novolyte Technologies). A polypropylene membrane (25 μm in thickness, Celgard 2500) was used as a separator between the two electrodes.

### Battery Characterizations

After assembly, the coin cells were placed in a home-built environmental box with a temperature variation less than ±0.2° C. and measured by a 16-channel battery analyzer station (Neware, China; current range: 1 μA to 1 mA). Data were collected and analyzed using the accompanying software. For all data except those noted, the measurements were conducted at 30° C. The cyclic voltammetry measurements were performed in a three-electrode configuration with lithium ribbons (Sigma; 1 mm thick) as the counter and reference electrodes, respectively. The working and counter electrodes were rolled together by the separator. All three electrodes were dipped in an electrolyte of the same composition as noted above. The entire setup was kept in a plastic box placed in the glovebox to minimize environmental influences. A CHI 600C potentiostat/galvanostat was used for the measurement, as is described below.

### Structural Characterizations

Structural characterizations were performed on a scanning electron microscope (SEM, JEOL 6340F) and a transmission electron microscope (TEM, JEOL 2010F). Elemental analysis was carried out using the energy dispersion spectrometer attached to the TEM.

### Example 2

### Material Characterization

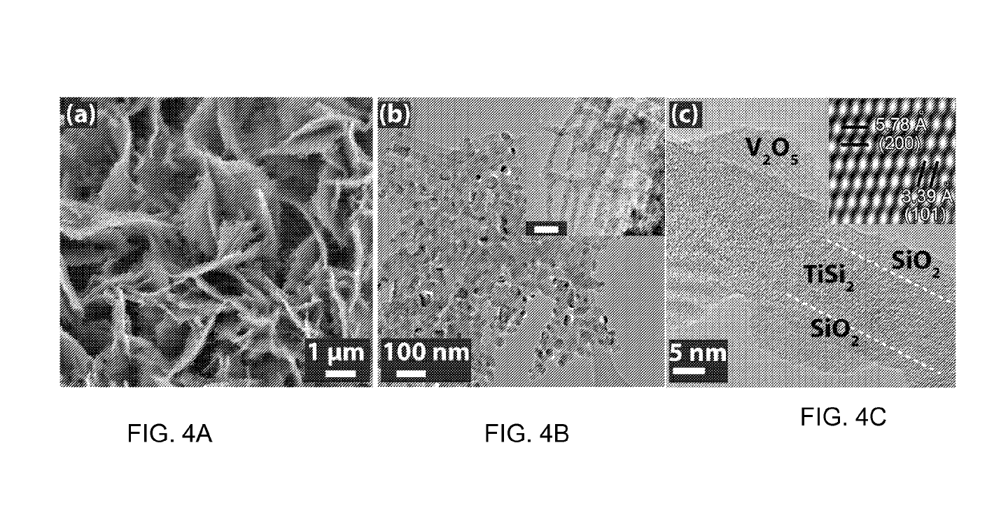

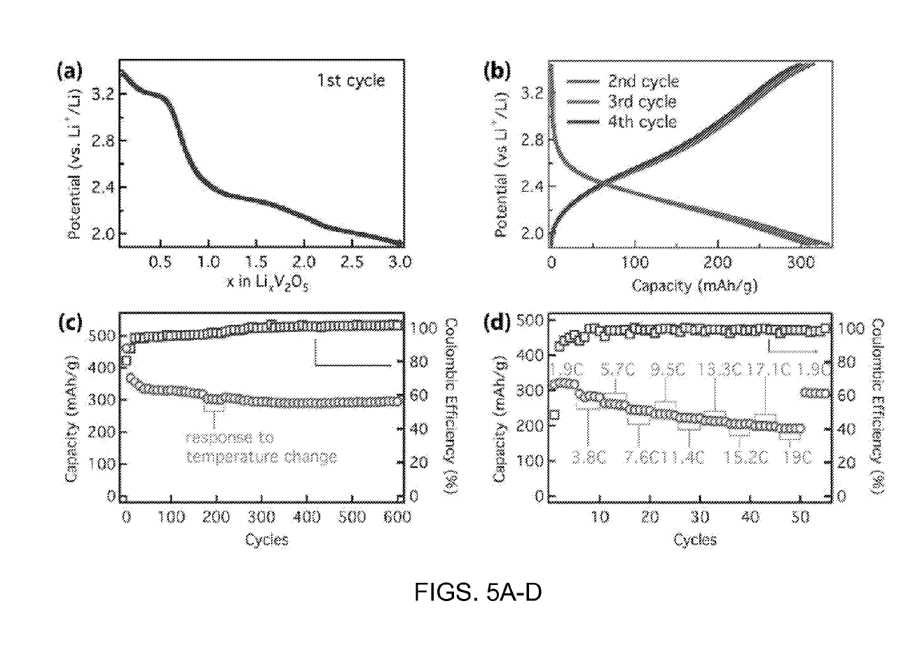

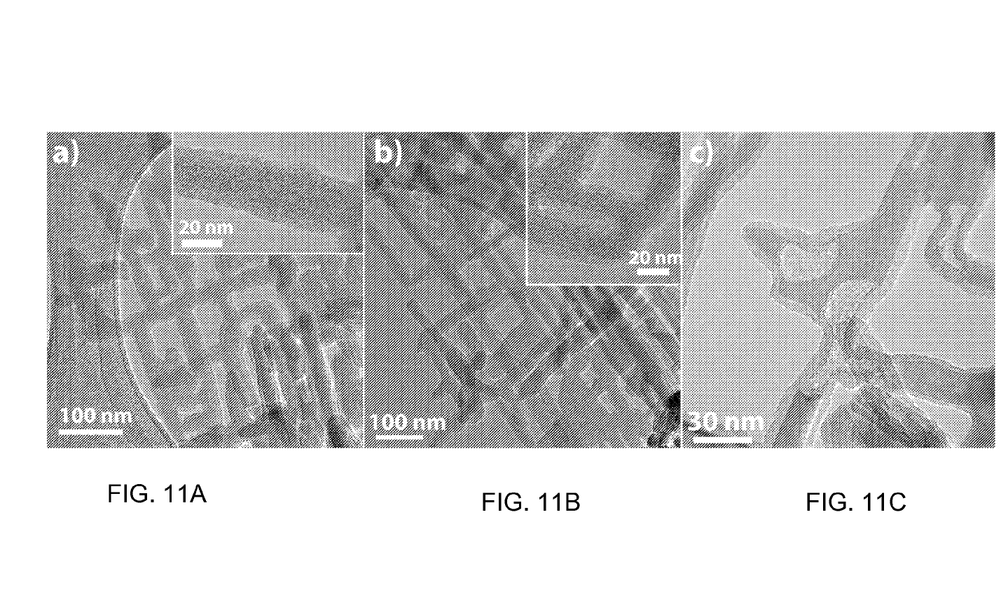

The TiSi₂ nanonets were synthesized by chemical vapor deposition (CVD) without the involvement of catalysts or growth seeds. The growth was readily carried out on conductive substrates (e.g., Ti foil) that can be used as current collectors, and as such the resulting materials were directly assembled into coin cells for battery characterizations without the need for binders or other additives. The deposition of vanadium precursor, triisopropoxyvandium(V) oxide (VOTP), is a variant of the sol-gel method, which is straightforward to implement. Upon calcination at 500° C. in O₂, discrete nanoparticles (typically 20-30 nm in diameters) formed, as shown in FIG. 4B. These nanoparticles were identified as Ti-doped V₂O₅ (˜5% Ti) by elemental analysis, as is described in more detail in Example 7 below. The Ti came from the TiSi₂ nanonets, whose top surface layers were converted to SiO₂ by calcination in the absence of VOTP, as shown in FIG. 11A and FIG. 11B. The SiO₂ coating plays an extremely important role in protecting the conductive framework, as will be discussed later. Although the crystalline nanonets were transformed into amorphous during calcination, the nanonet morphology was preserved. More important, the conductivity (4×10³ S/cm) of amorphous TiSi₂ is several orders of magnitude of that of V₂O₅ (˜10⁻³-10⁻² S/cm), thereby enabling high power rate that has not been measured on V₂O₅ alone.

Electron micrographs of TiSi₂/V₂O₅ heteronanostructures are shown in FIG. 4A, FIG. 4B, and FIG. 4C. FIG. 4A is a top-view scanning electron micrograph (SEM) showing the high yield of the nanonets, supporting that this approach can produce high content of active materials. FIG. 4B is a low magnification transmission electron micrograph (TEM) demonstrating the particulate nature of V₂O₅ coating and the inter-connectivity of TiSi₂ nanonets. Because the nanonet morphology is less apparent with regular loading of V₂O₅ (main frame), the nanostructures at reduced loading of V₂O₅ is shown in the inset (scale bar: 100 nm; with ˜30% less V₂O₅ loading than that in the main frame). FIG. 4C is a high magnification TEM revealing the details of the heteronanostructure, where an amorphous SiO₂ layer is present (portions of the interface between TiSi₂ and SiO₂ highlighted by white doted lines). The resulting V₂O₅ is highly crystalline, as shown inset.

### Example 3

### Behavior of TiSi₂/V₂O₅ Nanostructures in a Coin Cell Configuration

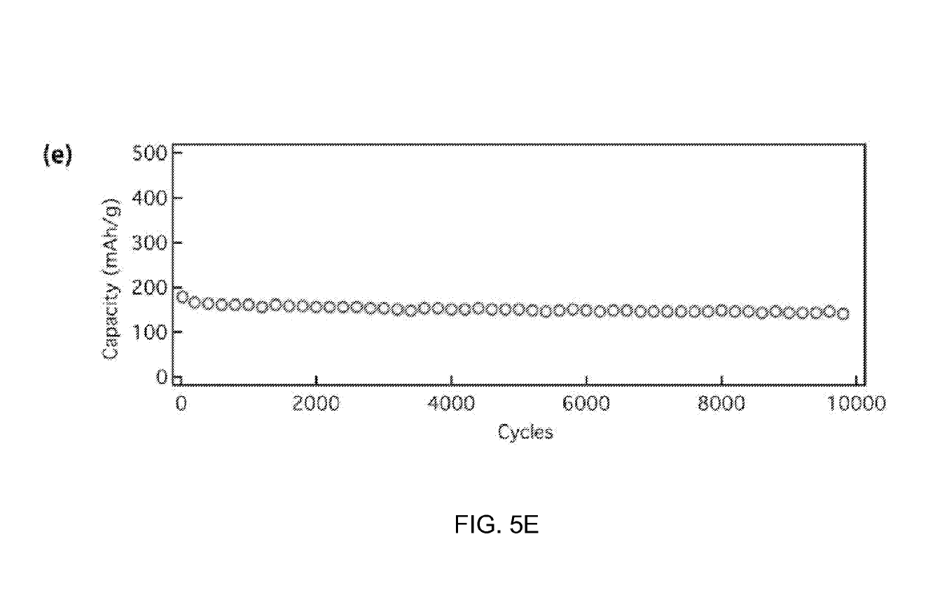

At a rate of 60 mA/g (ca. 0.2 C; 1 C=350 mA/g), the material exhibited discharge (lithiation; see FIG. 5A) and charge (delithiation) behaviors characteristic of that by V₂O₅. The lithiation process took place within the potential window of 3.45 and 1.9 V, the plateaus at 3.2 V, 2.3 V, and 2.0 V corresponding to the formation of LiV₂O₅, Li₂V₂O₅, and Li₃V₂O₅, respectively. The end product of the first lithiation process was ω-Li₃V₂O₅, which then underwent reversible lithiation and delithiation as shown in FIG. 5B. The result is important because it proves that the addition of TiSi₂ does not alter the chemical properties of V₂O₅ to a measurable extent. Impedance measurements confirmed that the Li⁺ diffusion coefficient within TiSi₂/V₂O₅ nanostructures is similar to that in bulk V₂O₅, and the resistance between TiSi₂ and V₂O₅ was insignificant.

### Example 4

### Behavior of TiSi₂/V₂O₅ Nanostructures Upon Prolonged Charge/Discharge

The rate was set at ca. 0.9 C (300 mA/g). After the initial decrease during the first 40 cycles from 461 mAh/g to 334 mAh/g (27.5%), the capacity remained stable during the remainder of the test for up to 600 cycles, fading only 12%. It corresponds to an average capacity decrease of 0.023% per cycle, a remarkable value considering that the test was carried out at a reasonably fast rate. It is worth noting an initial discharge capacity of 461 mAh/g, higher than the aforementioned limit (350 mAh/g), was measured presumably due to the irreversible processes such as the solid-electrolyte-interface (SEI) layer formation. Consistent with this result was the relatively low Coulombic efficiencies during the initial cycles (81% for the 1^{st} cycle), which gradually reached a level >99% after 200 cycles. The TiSi₂/V₂O₅ nanostructures were also examined at different charge/discharge rates, and the results were plotted in FIG. 5D. At 19 C (6,660 mA/g), the measured capacity of 192 mAh/g corresponded to a discharge power rate of 14.5 kW/kg, as is described in more detail below, one of the highest measured on V₂O₅-based cathode materials. Greater than 93% of the initial capacity was recovered when the cell was measured at 1.9 C again after the varying-rates measurements.

FIGS. 5A-5E summarize charge and discharge behaviors of TiSi₂/V₂O₅ heteronanostructures. FIG. 5A presents that the first cycle of discharge (lithiation) is characteristic of crystalline V₂O₅. The rate of measurement was 60 mA/g. FIG. 5B shows that after discharge V₂O₅ is amorphous, as confirmed by the charge/discharge behaviors. The rate of measurement was 540 mA/g. FIG. 5C shows that after the initial decay during the first 40 cycles, the heteronanostructure exhibited stability for up to 600 cycles, fading only 12%. The rate of measurement was 300 mA/g. Also worth noting is the reversible decrease of capacity between the 180^{th} and 210^{th} cycles (14 mAh/g, or 4.4%) as a result of controlled temperature change from 30.0° C. to 28.0° C. For clarity, one data point for every 10 cycles is shown. FIG. 5D represents rate-dependent specific capacities. 1 C: 350 mA/g, normalized electrical current (against the mass of electrode materials where 1 C means the electrode will be fully charged (or discharged) during 1 hr of time. FIG. 5E shows that, at the rate of 25 C, an initial specific capacity of 168 mAh/g is measured; this value is 132 mAh/g after 9,800 cycles of repeated charge/discharge, corresponding to a capacity retention of 78.7%. For clarity, one data point for every 200 cycles is shown. Coulombic efficiency is maintained at >99% during the test (not shown for clarity reasons).

### Example 5

### Stability of TiSi₂/V₂O₅ Nanostructures

The stability of TiSi₂/V₂O₅ nanostructures was measured after extended charge/discharge cycles at relatively fast rates. FIG. 5E shows the stability of TiSi₂/V₂O₅ at a rate of 25° C., where a specific capacity of 168 mAh/g was measured. The combined high power and high capacity exhibited by TiSi₂/V₂O₅ nanostructures of the present disclosure is only exhibited by devices made of thin film. The TiSi₂/V₂O₅ nanostructures of the present disclosure reported here is fundamentally different from thin films in the loading densities of active materials. Because the overall dimension of the TiSi₂ nanonets is in the micron range, and the nanonets naturally grow into packed structures, the density of active materials can be comparable to other powder-based technologies. Even though the packing density of TiSi₂ nanonets was not optimized for the instant experiments, an areal density of up to 2 mg/cm² was achieved. In some embodiments, the areal density can be further increased through nanonets growth optimizations.

### Example 6

### Characterization of the TiSi₇/V₂O₅ Nanostructures after 1,500 Charge/Discharge Cycles

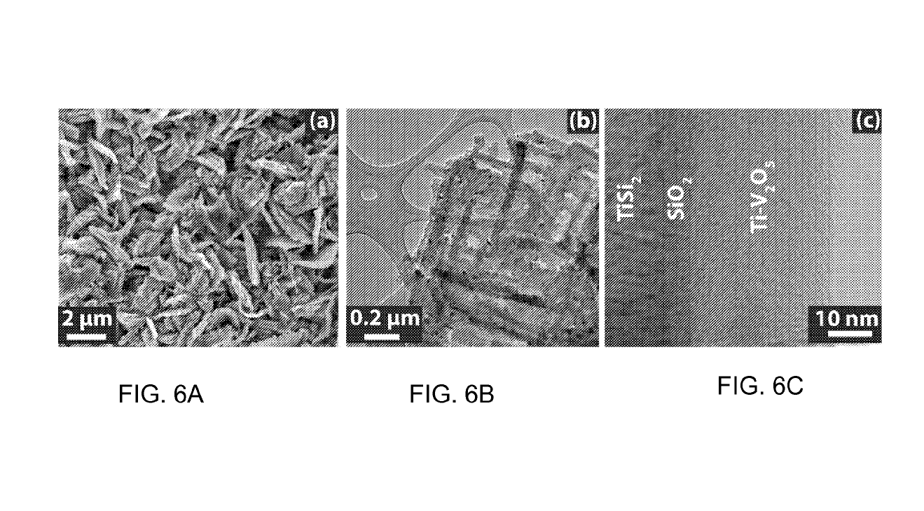

The nanostructures of the present disclosure were analyzed by TEM after 1,500 cycles of repeated charge/discharge. As shown in FIG. 6A. FIG. 6B and FIG. 6C, the overall structure remained except that the crystalline V₂O₅ nanoparticles turned amorphous due to the initial lithiation process. It thus appears that the Ti-doping within V₂O₅ plays a positive role in stabilizing the lattice upon lithiation and delithiation. It is noted that TiO₂ does not participate in the reactions within the voltage range of 3.45 to 2 V, ruling out potential contributions from oxides other than V₂O₅ in the system. The TiSi₂ core and SiO₂ protection coating were also intact after the extended test. Control experiments revealed that the SiO₂ contributed to the measured stability, without which the TiSi₂ nanonet morphology was nearly indistinguishable after 175 cycles. That morphological degradation was accompanied by capacity decrease, further confirming that maintaining a highly conductive core in its intact form results in the high stability as reported herein.

FIG. 6A, FIG. 6B, and FIG. 6C present an analysis of TiSi₂N₂O₅ hetero-nanostructures after 1,500 cycles of repeated charge/discharge. FIG. 6A is an SEM image showing that the overall morphology of the electrode material remains unchanged after the prolonged test. FIG. 6B is a low magnification TEM image revealing that the inter-connectivity of the TiSi₂ nanonet is maintained, proving that the nanonet is preserved during the charge/discharge process. The particulate nature of V₂O₅, as shown in FIGS. 4A-4C, is no longer apparent as the repeated lithiation/delithiation processes have turned V₂O₅ amorphous. FIG. 6C is a high magnification TEM image further confirming the TiSi₂ core is protected. The V₂O₅ nanoparticles, now amorphous and in a form of continuous films, remain connected to the nanonets.

### Example 7

### Energy Dispersive Spectroscopy (EDS) of Ti—V₂O₅ Particles

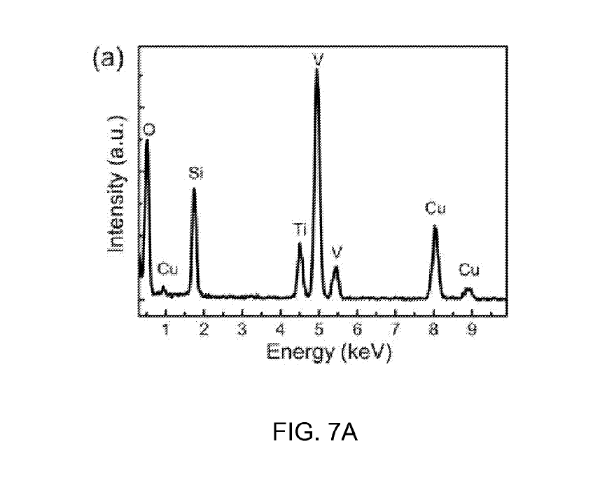

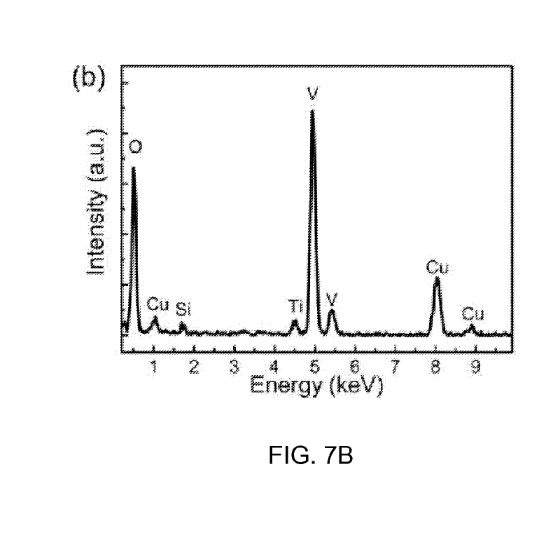

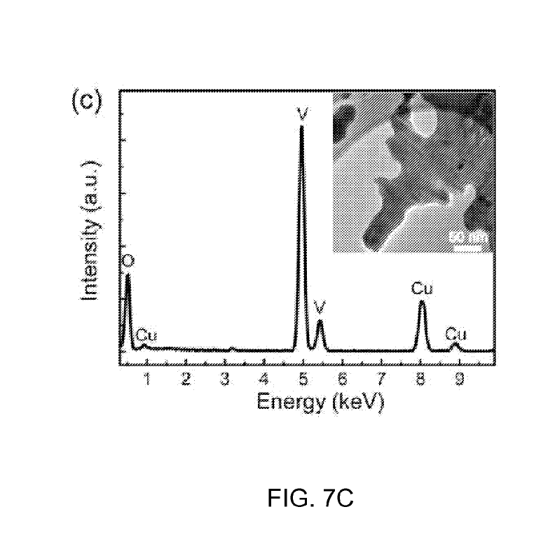

FIG. 7A, FIG. 7B, and FIG. 7C present results of Energy Dispersive Spectroscopy (EDS) analysis of Ti—V₂O₅ particles. FIG. 7A is the spectrum of the overall structure, from which a V:Ti:Si ratio of 4.7:1:2.4 was obtained, corresponding to a V₂O₅ weight percentage of approximately 80%. FIG. 7B is the spectrum of a representative V₂O₅ nanoparticle. Ti content accounts for ca. 5% (by atoms) and Si for ca. 3%. It should be noted that Si may play a role to improve the stability of V₂O₅ upon lithiation/delithiation. FIG. 7C is the spectrum of the shell after the initial hydrolysis step and prior to annealing. The C signal was beyond the detection limit and therefore did not show up. The Cu signal came from the sample holder. This spectrum shows that there was no Ti or Si in the V precursor (VOTP). It also shows that the detected Ti and Si signals in FIG. 7B were not from the TiSi₂ core.

### Example 8

### Delithiation characteristics of the first cycle

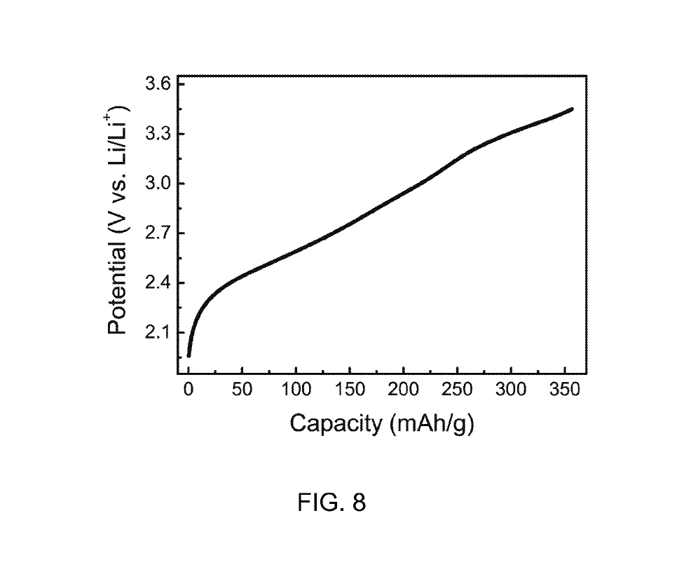

FIG. 8 presents a graph showing charge characteristic of the first cycle at a rate of 540 mA/g. The gradual increase of potentials between 2.4 and 3.4 V is characteristic of converted ω-Li₃V₂O₅. The measured capacity of 350 mAh/g also matches what is expected from ω-Li₃V₂O₅.

### Example 9

### Electrochemical impedance spectroscopy measurement

The Electrochemical Impedance Spectroscopy (EIS) measurement was carried out using the coin cell configuration. The TiSi₂N₂O₅ heterostructures were first fully lithiated to 1.9 V at 60 mA/g, followed by an equilibrating process of 2 hr. The frequency was set between 50 kHz and 0.1 Hz, with an AC amplitude of 10 mV. The measurement was performed on a CHI 600C Potentiostat/Galvanostat, and software “Zsimpwin” was used for data simulation.

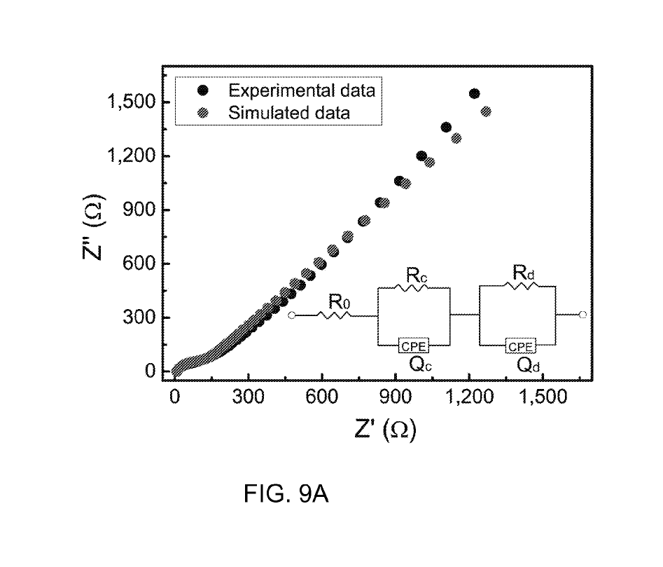

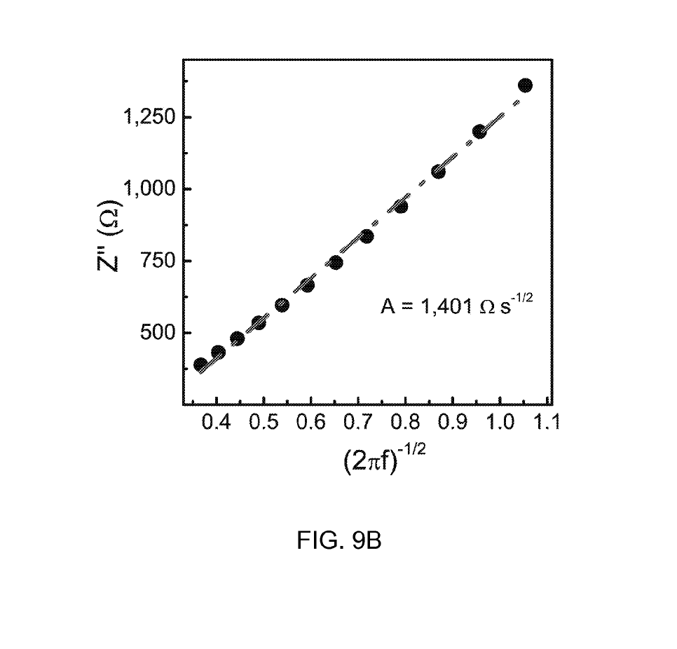

The Nyquist plot of TiSi₂/V₂O₅ heterostructures electrode at 1.9 V is shown in FIG. 9A. Black dots represent the experimental data and red dots are obtained by fitting the experimental data with the inset equivalent electric circuit (EEC). The graph was fit using the inset equivalent electric circuit (EEC). The Nyquist plot consists of a semi-circle and an inclined line, which contains the information of charge transfer and Li⁺ diffusion in the electrode respectively. Two R//Q elements, R_{c}//Q_{c} and R_{d}//Q_{d}, were employed to simulate these processes, resulting a fitting error of 1.68×10⁻³ (χ² value between experimental and simulated data). From this result, the R_{c} value was determined as 86.43Ω, indicating a low charge transfer resistance in the electrode.

The Li⁺ diffusion coefficient (D_{Li}⁺) within V₂O₅ was calculated using the impedance measurement. Based on the model proposed by Ho et al (Ho, C.; Raistrick, I. D.; Huggins, R. A., Application of A-C Techniques to the Study of Lithium Diffusion in Tungsten Trioxide Thin Films. J. Electrochem. Soc. 127, 343-350 (1980), D_{Li}⁺ can be calculated from the Warburg impedance part according to the following equation:

A=|Vₘ(δE/δx)/(\sqrt{2}FD^{1/2}S)|

Where Vₘ is the mole volume of V₂O₅, S is the surface area of the electrode, F is the Faraday constant (96,486 C/mol), δE/δx is the slope of galvanostatic charge/discharge curves, and A is the slop of Z″ vs (2πf)^{-1/2}, as shown in FIG. 9B.

### Example 10

### Influence of Temperature on Capacity

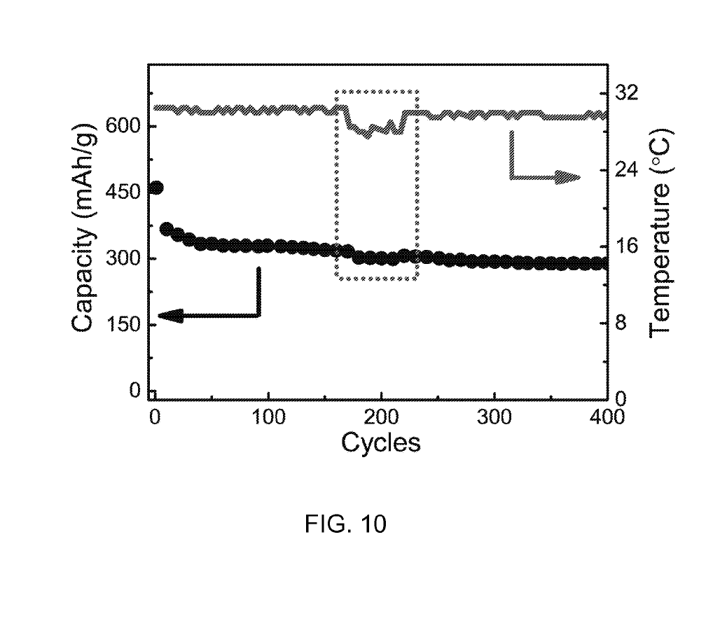

FIG. 10 shows the dependence between temperature and capacity of a cathode of the present disclosure. Usually the environmental temperature is controlled at 30° C. Upon controlled decrease to 28° C., a 4.4% capacity loss was observed, as indicated in the blue rectangle region.

The blue rectangle region indicates a temperature decrease from 30° C. to 28° C. An isothermal station (Thermo Scientific, SC 100; with an accuracy of ±0.02° C. within its water bath) was used to control the temperature and a separate thermal couple (Lascar Electronics, EL-USB-TC-LCD; with an accuracy of ±1° C.) to record the temperature in the measurement box. The fluctuation in the recorded temperature is likely a result of the inaccuracy of the thermal couple because during the experiments, the isothermal station's temperature was stable.

### Example 11

### Power Density Calculation Details

The power density of half-cell dₚ was calculated by the equation: dₚ=C×V/t, where C is the capacity, V is the average discharge potential and t is the time of one discharge segment. Based on the discharge characteristic of V₂O₅, an average discharge potential of 2.2 V was used for the calculation. At 19 C (6,650 mA/g), the measured capacity of 192 mAh/g was reached within a discharge time of 104 s, corresponding to a power density of 14.5 kW/kg.

### Example 12

### TEM Analysis of TiSi₂ Nanonets

FIG. 11A, FIG. 11B, and FIG. 11C represent TEM images of TiSi₂ nanonets. FIG. 11A is a TEM image of TiSi₂ annealed at 500° C. for 2 hours, including a magnified view showing the existence of the SiO₂ coating inset. FIG. 11B is a TEM image of TiSi₂ with SiO₂ coating after 175 cycles of repeated charge/discharge within 3.45 and 1.9 V. The morphology is comparable to that in FIG. 11A. FIG. 11C is a TEM image of TiSi₂ without SiO₂ after the same test. Without the protection of SiO₂, etching of TiSi₂ has occurred. The shell surrounding the voids left by removed TiSi₂ is the carbon-containing SEI layer.

In the absence of VOTP, the surface of TiSi₂ nanonets was converted to SiO₂ upon annealing in O₂. The morphology of the annealed nanonets is shown in FIG. 11A. The thickness of SiO₂ was approximately 4 nm. To understand the role of SiO₂ coating in protecting the conductive framework, TiSi₂ was analyzed with and without the SiO₂ coating in battery tests within the potential window of 3.45˜1.9 V. The morphologies of these materials were characterized by TEM after 175 cycles of test. The one with SiO₂ coating, as indicated by FIG. 11B, maintained its morphology. Clear destruction was observed on samples without the SiO₂ coating, as is shown in FIG. 11C. This shows that SiO₂ protects TiSi₂ from being etched by reactions with Li % which is important for the stability of the TiSi₂/V₂O₅ heteronanostructures.

### Example 13

### Current-Voltage Measurement

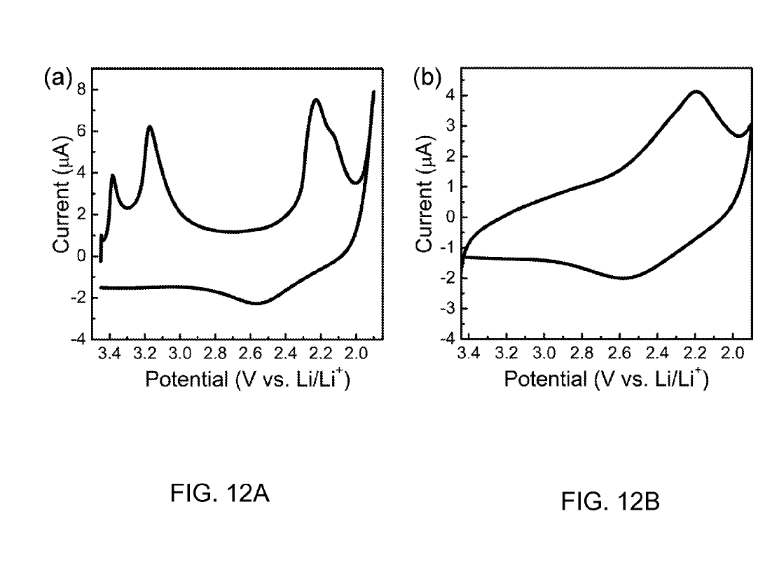

FIG. 12A and FIG. 12B represent current-voltage characteristics of TiSi₂/V₂O₅ nanostructures. FIG. 12A shows the first cycle and FIG. 12B shows the second cycle. The data was recorded at a scan rate of 1 mV/s.

In some embodiments, an electrode includes a plurality TiSi₂ two-dimensional (2D) conductive nanonets formed on a platinum coated titanium substrate, wherein titanium-doped V₂O nanoparticles are deposited on the surface of the TiSi₂ nanonets and a SiO₂ coating is formed on the surface of the TiSi₂ nanonets to protect the TiSi₂ nanonets.

In some embodiments, a Li-ion rechargeable battery includes a cathode comprising a plurality TiSi₂ two-dimensional (2D) conductive nanonets formed on a platinum coated titanium substrate, wherein titanium-doped V₂O nanoparticles are deposited on the surface of the TiSi₂ nanonets and a SiO₂ coating is formed on the surface of the TiSi₂ nanonets to protect the TiSi₂ nanonets.

In some embodiments, a method of fabricating a hetero-nanostructure material-based electrodes includes performing chemical vapor deposition in a reaction chamber to form on a substrate a plurality of TiSi₂ nanonets, partially hydrolyzing in a glove box V₂O₅ active material precursor; completing hydrolysis of the V₂O₅ active material precursor in an ambient environment, and calcining the TiSi₂ nanonets to form Ti-doped V₂O₅ active material nanoparticles and a SiO₂ protective coating on the surface of the TiSi₂ nanonets.

In some embodiments, a hetero-nanostructure material includes a silicide nanoplatform, ionic host nanoparticles disposed on the silicide nanoplatform and in electrical communication with the silicide nanoplatform, and a protective coating disposed on the silicide nanoplatform between the ionic host nanoparticles.

In some embodiments, a hetero-nanostructure material includes a plurality of connected and spaced-apart nanobeams comprising a silicide core, ionic host nanoparticles formed on the silicide core, and a protective coating formed on the silicide core between the ionic host nanoparticles.

In some embodiments, an electrode for a lithium battery includes a silicide nanoplatform formed on a substrate, ionic host nanoparticles disposed on the silicide nanoplatform and in electrical communication with the silicide nanoplatform, and a protective coating disposed on the silicide nanoplatform between the ionic host nanoparticles. In some embodiments, the nanoplatform includes a plurality of connected and spaced-apart nanobeams linked together at an about 90-degree angle. In some embodiments, the electrode of the present disclosure includes a titanium silicide nanoplatform which functions to facilitate charge transport, titanium doped vanadium pentoxide nanoparticles which function as an active component to store and release lithium-ion (Li⁺), and silicon oxide protective coating which functions to prevent Li⁺ from reacting with the silicide nanoplatform.

In some embodiments, a method of fabricating a hetero-nanostructure material that includes forming a two-dimensional silicide nanonet including a plurality of connected and spaced-apart nanobeams; depositing precursor for an ionic host material on a surface of the silicide nanonet; and forming ionic host material nanoparticles on the surface of the silicide nanonet and a protective coating between the nanoparticles.

All patents, patent applications, and published references cited herein are hereby incorporated by reference in their entirety. It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A hetero-nanostructure material comprising a silicide nanoplatform, ionic host nanoparticles disposed on the silicide nanoplatform and in electrical communication with the silicide nanoplatform, and a protective coating disposed on the silicide nanoplatform between the ionic host nanoparticles.

2. The hetero-nanostructure material of claim 1 wherein the nanoplatform comprises a plurality of connected and spaced-apart nanobeams linked together at an about 90-degree angle.

3. The hetero-nanostructure material of claim 1 further comprising a substrate for supporting the silicide nanoplatform.

4. The hetero-nanostructure material of claim 1 wherein the silicide nanoplatform is made from a material selected from the group consisting of titanium silicide, nickel silicide, iron silicide, platinum silicide, chromium silicide, cobalt silicide, molybdenum silicide, tantalum silicide and combinations thereof.

5. (canceled)

6. The hetero-nanostructure material of claim 1 wherein the ionic host nanoparticles are selected from the group consisting of vanadium pentoxide, lithium cobalt oxide, lithium iron phosphate, lithium manganese oxide, lithium nickel oxide, and combinations thereof.

7. (canceled)

8. The hetero-nanostructure material of claim 1 wherein the ionic host nanoparticles are titanium doped vanadium pentoxide nanoparticles.

9. A hetero-nanostructure material comprising a plurality of connected and spaced-apart nanobeams comprising a silicide core, ionic host nanoparticles formed on the silicide core, and a protective coating formed on the silicide core between the ionic host nanoparticles.

10. The hetero-nanostructure material of claim 9 wherein the beams are linked together at an about 90-degree angle.

11. The hetero-nanostructure material of claim 9 wherein the silicide core is made from titanium silicide.

12. The hetero-nanostructure material of claim 9 wherein the ionic host nanoparticles are titanium doped vanadium pentoxide nanoparticles.

13. The hetero-nanostructure material of claim 9 wherein the protective coating is silicon oxide.

14. An electrode for a lithium battery comprising a silicide nanoplatform formed on a substrate, ionic host nanoparticles disposed on the silicide nanoplatform and in electrical communication with the silicide nanoplatform, and a protective coating disposed on the silicide nanoplatform between the ionic host nanoparticles.

15. The electrode of claim 14 wherein the silicide nanoplatform comprises a plurality of connected and spaced-apart nanobeams linked together at an about 90-degree angle.

16. The electrode of claim 14 wherein the silicide nanoplatform is made from titanium silicide.

17. The electrode of claim 14 wherein the ionic host nanoparticles are titanium doped vanadium pentoxide nanoparticles.

18. The electrode of claim 14 wherein the silicide nanoplatform functions to facilitate charge transport.

19. The electrode of claim 14 wherein the ionic host nanoparticles function as an active component to store and release lithium-ion (Li⁺).

20. The electrode of claim 14 wherein the protective coating functions to prevent lithium-ion (Li⁺) from reacting with the silicide nanoplatform.

21. The electrode of claim 14 wherein the electrode functions as a cathode in the lithium battery.

22. A method of fabricating a hetero-nanostructure material comprising:
forming a two-dimensional silicide nanonet including a plurality of connected and spaced-apart nanobeams;
depositing precursor for an ionic host material on a surface of the silicide nanonet; and
forming ionic host material nanoparticles on the surface of the silicide nanonet and a protective coating between the nanoparticles.

23. (canceled)

24. (canceled)

25. (canceled)
